(19) United States
(12) Patent Application Publication
(10) Pub. No.: US 2026/0152136 A1
(43) Pub. Date: Jun. 4, 2026

(54) IN-VEHICLE COMMUNICATION SYSTEM, CONTROL DEVICE AND ELECTRICAL DEVICE

(71) Applicants: SUMITOMO ELECTRIC INDUSTRIES, LTD., Osaka-shi, Osaka (JP); SUMITOMO WIRING SYSTEMS, LTD., Yokkaichi-shi , Mie (JP); AUTONETWORKS TECHNOLOGIES, LTD., Yokkaichi-shi , Mie (JP)

(72) Inventors: Yuto UENO, Osaka-shi (JP); Yuta MIYAGAWA, Osaka-shi (JP); Yuya TANAKA, Osaka-shi (JP); Susumu TAKESHIMA, Osaka-shi (JP)

(73) Assignees: SUMITOMO ELECTRIC INDUSTRIES, LTD., Osaka-shi, Osaka (JP); SUMITOMO WIRING SYSTEMS, LTD., Yokkaichi-shi , Mie (JP); AUTONETWORKS TECHNOLOGIES, LTD., Yokkaichi-shi , Mie (JP)

(21) Appl. No.: 19/121,936

(22) PCT Filed: Jul. 12, 2023
(86) PCT No.: PCT/JP2023/025716

§ 371 Date: Apr. 17, 2025

(30) Foreign Application Priority Data
Oct. 27, 2022 (JP) 2022-171949

(51) Int. Cl. B60R 16/033; B60R 16/023; H04L 12/40

(52) U.S. Cl. CPC B60R 16/033; B60R 16/0231; H04L 12/40045; H04L 2012/40215; H04L 2012/40273

(57) ABSTRACT

An in-vehicle communication system that includes: a first control device; and a plurality of first electrical devices, wherein: the first control device includes: a first power source configured to output power; a plurality of first communication interfaces respectively corresponding to the plurality of first electrical devices; a plurality of first communication paths respectively corresponding to the plurality of first communication interfaces; and a first processor configured to judge first priority levels for supplying power from the first power source to the plurality of first electrical devices.

### BACKGROUND

The present disclosure relates to an in-vehicle communication system, a control device, and an electrical device. This application claims priority based on Japanese Patent Application No. 2022-171949 filed on Oct. 27, 2022, the entire contents of which are incorporated herein by reference.

In a vehicle such as an automobile, various electrical devices mounted therein (e.g., a camera, a sensor, and a car navigation system) are supplied with power from an in-vehicle battery. For example, in a plug-in hybrid electric vehicle (PHEV) or electric vehicle (EV), the output voltage of a high voltage battery for driving a motor is converted to an appropriate voltage by a power conversion device and supplied to electrical devices inside the vehicle.

JP H10-154964A below discloses a data communication system that judges whether or not it is possible to supply power, with consideration given to the supply ability of the power supplier and the capacity of the device receiving the power.

### SUMMARY

An in-vehicle communication system according to one aspect of the present disclosure is an in-vehicle communication system including: a first control device; and a plurality of first electrical devices, in which the first control device includes: a first power source unit configured to output power; a plurality of first communication units respectively corresponding to the plurality of first electrical devices; a plurality of first communication paths respectively corresponding to the plurality of first communication units; and a first priority level judgment unit configured to judge first priority levels for supplying power from the first power source unit to the plurality of first electrical devices, the first priority level judgment unit transmits a first transmission request from the plurality of first communication units to each of the plurality of first electrical devices via the plurality of first communication paths, each of the plurality of first electrical devices transmits information indicating importance and required power of the first electrical device to the first control device via the corresponding first communication path in response to the first transmission request, and the first priority level judgment unit judges the first priority levels based on the information indicating the importance and the required power received from the plurality of first electrical devices.

### BRIEF DESCRIPTION OF THE DRAWINGS

FIG. 1 is a block diagram showing a configuration of an in-vehicle communication system according to a first embodiment of the present disclosure.

FIG. 2 is a block diagram showing a configuration of a priority level judgment unit shown in FIG. 1.

FIG. 3 is a block diagram showing a configuration of a power over data line (PoDL) unit shown in FIG. 1.

FIG. 4 is a block diagram showing a configuration of a control unit of the electrical device shown in FIG. 1.

FIG. 5 is a flowchart showing processing to be executed by the control device shown in FIG. 1.

FIG. 6 is a flowchart showing processing to be executed by the electrical device shown in FIG. 1.

FIG. 7 is a flowchart showing processing to be executed by a control device according to a first variation.

FIG. 8 is a block diagram showing a configuration of an in-vehicle communication system according to a second embodiment.

FIG. 9 is a block diagram showing a configuration of a priority level judgment unit of a second control device shown in FIG. 8.

FIG. 10 is a block diagram showing a configuration of a control unit of an electrical device connected to the first control unit and the second control unit shown in FIG. 8.

FIG. 11 is a flowchart showing processing executed by the first control device shown in FIG. 8.

FIG. 12 is a flowchart showing processing executed by the second control device shown in FIG. 8.

FIG. 13 is a flowchart showing processing executed by an electrical device according to a second variation.

### DETAILED DESCRIPTION OF EMBODIMENTS

### Problem to be Solved by the Present Disclosure

In a vehicle, electrical devices related to the basic functions of traveling, turning, and stopping are of relatively high importance and need to be supplied with power preferentially over other electrical devices of relatively low importance. However, this point is not taken into consideration in the data communication system disclosed in JP H10-154964A.

Accordingly, an object of the present disclosure is to provide an in-vehicle communication system, a control device, and an electrical device that can supply power preferentially to an electrical device having a specific function based on the importance of each electrical device among a plurality of electrical devices mounted in a vehicle.

### Advantageous Effects of the Present Disclosure

According to the present disclosure, it is possible to provide an in-vehicle communication system, a control device, and an electrical device that can supply power preferentially to an electrical device having a specific function based on the importance of each electrical device among a plurality of electrical devices mounted in a vehicle.

### Description of Embodiments of the Present Disclosure

The contents of embodiments of the present disclosure will be listed and described. At least some of the embodiments described below may be combined as appropriate.
(1) An in-vehicle communication system according to a first aspect of the present disclosure is an in-vehicle communication system including: a first control device; and a plurality of first electrical devices, in which the first control device includes: a first power source unit configured to output power; a plurality of first communication units respectively corresponding to the plurality of first electrical devices; a plurality of first communication paths respectively corresponding to the plurality of first communication units; and a first priority level judgment unit configured to judge first priority levels for supplying power from the first power source unit to the plurality of first electrical devices, the first priority level judgment unit transmits a first transmission request from the plurality of first communication units to each of the plurality of first electrical devices via the plurality of first communication paths, each of the plurality of first electrical devices transmits information indicating importance and required power of the first electrical device to the first control device via a first communication path of the plurality of first communication paths in response to the first transmission request, and the first priority level judgment unit judges the first priority levels based on the information indicating the importance and the required power received from the plurality of first electrical devices. This makes it possible to supply power preferentially to an electrical device having a specific function based on the importance of each electrical device among a plurality of electrical devices mounted in a vehicle.
(2) In (1) above, the first power source unit can supply the plurality of first electrical devices with communication power necessary for the plurality of first electrical devices to respectively communicate with the first control device via the plurality of first communication paths when the first priority level judgment unit transmits the first transmission request. This makes it possible to reduce unnecessary power consumption.
(3) In (1) or (2) above, the first control device may further include at least one superimposing unit, the superimposing unit may generate a superimposed signal by superimposing a communication signal output from a first communication unit of the plurality of first communication units and the power supplied from the first power source unit, and output the superimposed signal to the first communication path corresponding to the first communication unit that output the communication signal, and the superimposing unit may separate a signal including the information indicating the importance and the required power from a transmission signal transmitted from the first electrical device via the first communication path, and output the separated information to the first priority level judgment unit via the first communication unit corresponding to the first electrical device that output the transmission signal. This makes it possible to supply power to an electrical device by superimposing the power on a communication line that transmits a communication signal. Accordingly, the number of electrical wirings can be reduced.
(4) In (3) above, each of the plurality of first electrical devices may include: a separation unit configured to separate a signal including the first transmission request from the superimposed signal transmitted via the first communication path corresponding to the first electrical device; and a communication unit configured to transmit the information indicating the importance and the required power of the first electrical device to the first control device via the first communication path in response to the first transmission request separated by the separation unit. This makes it possible for the first control device to receive information indicating the importance and the required power of each of the plurality of first electrical devices from the plurality of first electrical devices, whereby it is possible to judge the first priority levels.
(5) In (4) above, the separation unit may further separate power from the superimposed signal transmitted via the first communication path corresponding to the first electrical device, and each of the plurality of first electrical devices may further include a power reception unit configured to first supply the power separated by the separation unit to the communication unit. This makes it possible for the first electrical devices to transmit information indicating the importance and the required power in response to a transmission request from the first control device.
(6) In any one of (1) to (5) above, the first priority level judgment unit may change the first priority levels according to a state of a vehicle in which the in-vehicle communication system is mounted. This makes it possible to determine appropriate priority levels according to the state of the vehicle. The importance of each of the electrical devices mounted in the vehicle changes depending on the state of the vehicle. Accordingly, power can be supplied preferentially to electrical devices having specific functions depending on the state of the vehicle.
(7) In any one of (1) to (6) above, the in-vehicle communication system may further include a second control device and a plurality of second electrical devices, in which at least one of the plurality of first electrical devices may be a specific electrical device, the second control device may include: a second power source unit configured to output power; a plurality of second communication units respectively corresponding to the plurality of second electrical devices and the specific electrical device; a plurality of second communication paths respectively corresponding to the plurality of second communication units; and a second priority level judgment unit configured to judge second priority levels for supplying power from the second power source unit to the plurality of second electrical devices and the specific electrical device, the second priority level judgment unit may transmit a second transmission request to each of the plurality of second electrical devices from the plurality of second communication units via the plurality of second communication paths, each of the plurality of second electrical devices may transmit information indicating importance and required power of the second electrical device to the second control device via a second communication path of the plurality of second communication paths in response to the second transmission request, the second priority level judgment unit may judge the second priority levels based on the information indicating the importance and the required power received from the plurality of second electrical devices, and in response to a reduction of the power supplied from the first power source unit to the specific electrical device, the second priority level judgment unit may change the second priority levels such that power is supplied from the second power source unit to the specific electrical device As a result, even when the power supplied from the first control unit to the specific electrical device is reduced, power can be supplied to the specific electrical device, and the specific electrical device can maintain its function.
(8) In (7) above, the first priority level judgment unit may notify the second priority level judgment unit of information indicating that the power supplied from the first power source unit to the specific electrical device is to be reduced. As a result, when the power supplied from the first control device to the specific electrical device is reduced, the second control device can efficiently start supplying power to the specific electrical device.
(9) In (7) above, the specific electrical device may notify the second priority level judgment unit of information indicating that the power supplied from the first power source unit to the specific electrical device is to be reduced. As a result, when the power supplied from the first control device to the specific electrical device is reduced, the second control device can efficiently start supplying power to the specific electrical device.
(10) In (8) or (9) above, the information indicating that power is to be reduced may include information indicating the importance and the required power of the specific electrical device. This makes it possible for the second control device to quickly change the priority levels such that power can be supplied to the specific electrical device.
(11) A control device according to a second aspect of the present disclosure is a control device to be mounted in a vehicle, including: a power source unit configured to output power; a plurality of communication units; and a priority level judgment unit configured to judge priority levels for supplying power from the power source unit to a plurality of electrical devices that are mounted in the vehicle and respectively correspond to the plurality of communication units via a plurality of communication paths respectively corresponding to the plurality of communication units, in which the priority level judgment unit transmits a transmission request to each of the plurality of electrical devices from the plurality of communication units via the plurality of communication paths, the priority level judgment unit receives, from each of the plurality of electrical devices, information indicating importance and required power of the electrical device in response to the transmission request via the communication path, and the priority level judgment unit judges the priority levels based on the information indicating the importance and the required power received from the plurality of electrical devices. This makes it possible for the control device to supply power to a plurality of electrical devices mounted in the vehicle based on the importance of each electrical device.
(12) A control device according to a third aspect of the present disclosure is a control device to be mounted in a vehicle, including: a power source unit configured to output power; a plurality of communication units; and a priority level judgment unit configured to judge priority levels for supplying power from the power source unit to a plurality of electrical devices mounted in the vehicle via a plurality of communication paths respectively corresponding to the plurality of communication units, in which at least one electrical device among the plurality of electrical devices is a specific electrical device, and the priority level judgment unit transmits a transmission request from the plurality of communication units via the plurality of communication paths to electrical devices other than the specific electrical device, the priority level judgment unit receives information indicating the importance and the required power of the electrical devices other than the specific electrical device via the communication paths in response to the transmission request, the priority level judgment unit judges the priority levels based on the information indicating the importance and the required power received from the electrical devices other than the specific electrical device, and in response to a reduction in power supplied to the specific electrical device from an in-vehicle device other than the control device, the priority level judgment unit changes the priority levels such that power is supplied to the specific electrical device from the power source unit. As a result, even if the power supplied to the specific electrical device from the in vehicle device other than the control device is reduced, power can be supplied to the specific electrical device, and the specific electrical device can maintain its function.
(13) A control device according to a fourth aspect of the present disclosure includes an electrical device to be mounted in a vehicle, including: a separation unit configured to separate a communication signal from a superimposed signal in which power and the communication signal are superimposed, the superimposed signal being transmitted from a control device mounted in the vehicle via a communication path; and a communication unit configured to transmit information indicating importance and required power of the electrical device to the control device via the communication path in response to a transmission request included in the communication signal. This makes it possible for the control device to supply power to the plurality of electrical devices mounted in the vehicle based on the importance of each electrical device.
(14) In (13) above, the separation unit can further separate the power from the superimposed signal transmitted via the communication path, and the electrical device can further include a power reception unit configured to first supply the power separated by the separation unit to the communication unit. This makes it possible for the electrical device to transmit the information indicating the importance and the required power.
(15) In (14) above, the electrical device may further include another separation unit configured to receive supply of power from an in-vehicle device other than the control device, that is mounted in the vehicle, via another path separate from the communication path in response to the power supplied from the control device being reduced, the other separation unit being separate from the separation unit, and the other separation unit may separate the power from a superimposed signal in which the power and the communication signal are superimposed and which is supplied from the in vehicle device via the other path, and outputs the separated power to the power reception unit. As a result, even when the power supplied from the control unit to the electrical device is reduced, it is possible to supply power to the electrical device, and the electrical device can maintain its function.

### DETAILS OF EMBODIMENTS OF THE PRESENT DISCLOSURE

In the following embodiments, identical components are denoted by identical reference numbers. Their names and functions are also identical. Accordingly, detailed description thereof is not repeated.

### First Embodiment

### Overall Composition

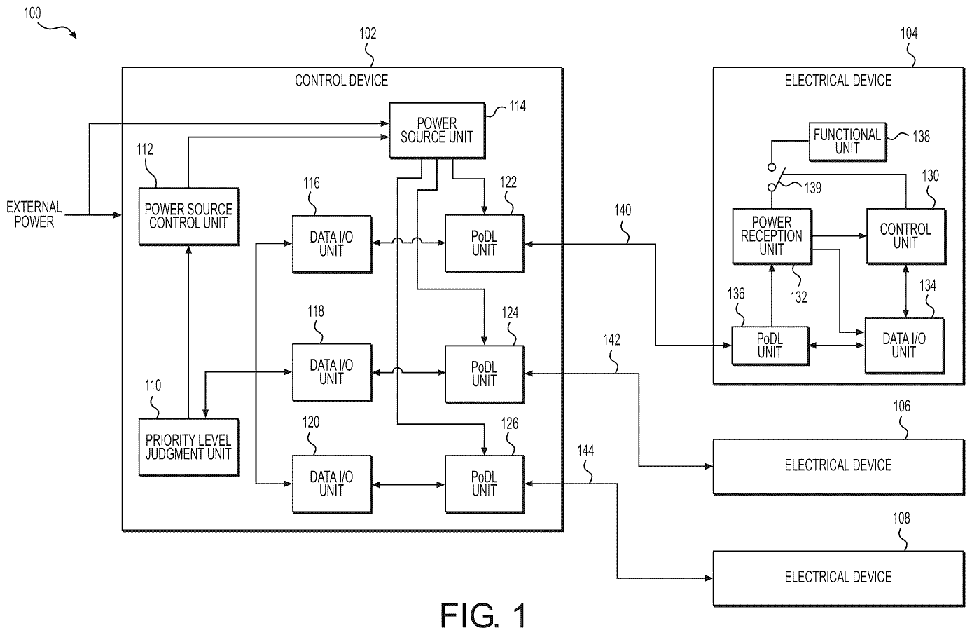

Referring to FIG. 1, an in-vehicle communication system 100 according to a first embodiment of the present disclosure includes a control device 102 and electrical devices 104, 106, and 108. The in-vehicle communication system 100 is mounted in a vehicle (not shown). The control device 102 is, for example, a central-electronic control unit (C-ECU). Each of the electrical devices 104, 106, and 108 is an in-vehicle camera, a sensor, a car navigation system, or the like, and is supplied with power from the control device 102. The control device 102 and the electrical devices 104, 106, and 108 are communicably connected by communication lines 140, 142, and 144, respectively. Each communication line constitutes a communication path for connecting an electrical device and a control unit. Note that although three electrical devices are shown in FIG. 1, the present disclosure is not limited to this. The control device 102 may also be electrically connected to two electrical devices. In addition, the control device 102 may be connected so as to be able to supply power to four or more electrical devices.

### Configuration of Control Device

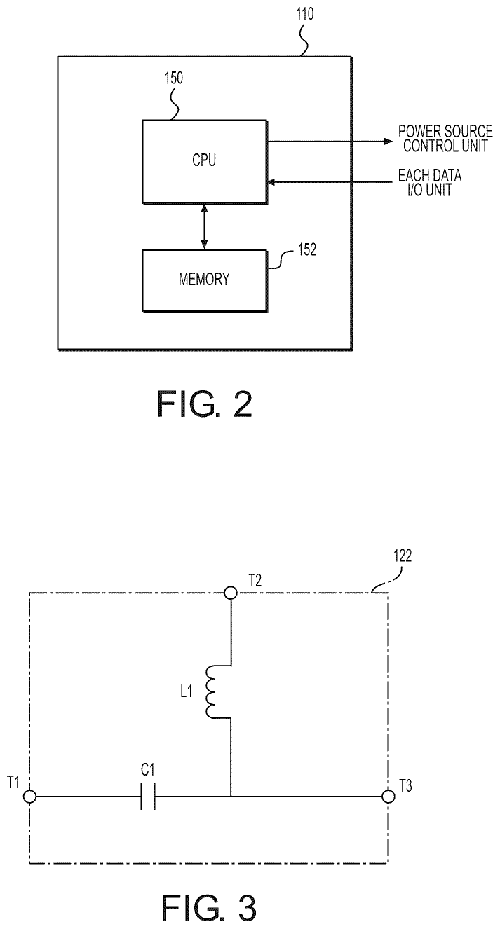

The control device 102 includes a priority level judgment unit 110 (processor), a power source control unit 112, a power source unit 114 (power source), data I/O units 116, 118, and 120, and PoDL units 122, 124, and 126. As described below, each data I/O unit and its corresponding PoDL unit constitute a communication unit (communication interface) by which the control device 102 communicates with each electrical device. With reference to FIG. 2, the priority level judgment unit 110 includes a central processing unit (CPU) 150 and a memory 152. The CPU 150 controls the memory 152. The memory 152 is, for example, a rewritable non-volatile semiconductor memory, and stores computer programs (hereinafter simply referred to as programs) to be executed by the CPU 150. The CPU 150 stores the results of the executed processing in the memory 152 as appropriate. The CPU 150 outputs data input from the data I/O units 116, 118, and 120 to the memory 152 for storage. Also, the CPU 150 reads out, from the memory 152, data to be output from the priority level judgment unit 110 to the power source control unit 112 and the data I/O units 116, 118, and 120, and outputs the data.

As described below, the priority level judgment unit 110 judges the priority levels for supplying power from the control device 102 to the electrical devices 104, 106, and 108, and outputs information indicating the priority levels determined through the judgment (hereinafter referred to as priority level information) to the power source control unit 112. The power source control unit 112 outputs, to the power source unit 114, information indicating the value of the power output from a plurality of ports of the power source unit 114 (hereinafter referred to as output power information) in accordance with the priority level information input from the priority level judgment unit 110. The power source unit 114 outputs power (i.e., DC power) of a specified magnitude from each output port in accordance with the output power information input from the power source control unit 112. The three output ports of the power source unit 114 are connected to the PoDL units 122, 124, and 126, respectively, and the output power of the power source unit 114 is input to the PoDL units 122, 124, and 126. Note that the power output by the power source unit 114 is generated from external power supplied from outside the control device 102 (power necessary for the operation of the control device 102, e.g., power obtained by converting the voltage of an in-vehicle battery (not shown) into a predetermined voltage).

The priority level judgment unit 110 acquires, from the electrical devices 104, 106, and 108, predetermined information for judging the above mentioned priority levels. For this purpose, the priority level judgment unit 110 outputs, via the data I/O units 116, 118 and 120, an instruction requesting the predetermined information (e.g., predetermined code data, hereinafter referred to as a transmission request). The predetermined information is information that indicates the function and required power of each electrical device. The required power means the power needed to allow operation of the electrical device. The required power is, for example, the rated value of the power consumption of each electrical device, and can be acquired from the specifications or instruction manual of each electrical device. The required power may also be determined from the power consumption measured when operating each electrical device. The data I/O units 116, 118, and 120 output communication signals corresponding to the transmission request input from the priority level judgment unit 110. The data I/O units 116, 118, and 120 are connected to the PoDL units 122, 124, and 126, respectively, and communication signals (i.e., transmission requests) output from the data I/O units 116, 118, and 120 are input to the PoDL units 122, 124, and 126.

Each of the PoDL units 122, 124, and 126 functions as a signal superimposing unit. That is, the PoDL unit 122 generates a signal (hereinafter referred to as a superimposed signal) in which a communication signal (e.g., a transmission request) input from the data I/O unit 116 and DC power input from the power source unit 114 are superimposed, and outputs the generated signal to the communication line 140. Similarly, the PoDL unit 124 superimposes a communication signal (e.g., a transmission request) input from the data I/O unit 118 and the DC power input from the power source unit 114, and outputs the superimposed signal to the communication line 142. The PoDL unit 126 superimposes a communication signal (e.g., a transmission request) input from the data I/O unit 120 and the DC power input from the power source unit 114, and outputs the superimposed signal to the communication line 144.

Each of the PoDL units 122, 124, and 126 includes, for example, a bias tee. For example, with reference to FIG. 3, the PoDL unit 122 includes a capacitor C1 disposed between a terminal T1 and a terminal T3, and an inductor L1 disposed between a terminal T2 and the terminal T3. When a communication signal (i.e., an AC signal) output from the data I/O unit 116 is input to the terminal T1 and DC power (i.e., a DC signal) output from the power source unit 114 is input to the terminal T2, a signal in which the AC signal is superimposed on a DC component is output from the terminal T3. Note that each of the PoDL units 122, 124, and 126 is not limited to a circuit using a capacitor and an inductor, but may also be constituted as a distributed constant circuit using a stub. The communication lines 140, 142, and 144 are realized by, for example, coaxial cables or twisted pair cables for transmitting differential signals.

In addition, each of the PoDL units 122, 124, and 126 functions also as a signal separation unit. That is, the PoDL unit 122 separates the AC component from the communication signal input via the communication line 140 (i.e., the signal in which the DC power from the power source unit 114 is biased), and outputs the separated AC component to the data I/O unit 116. With reference to FIG. 3, when the communication signal input to the PoDL unit 122 via the communication line 140 is input to the terminal T3, an AC component is output from the terminal T1. The output from the terminal T1 is input to the data I/O unit 116, and the data I/O unit 116 generates digital data and outputs the generated digital data to the priority level judgment unit 110. Similarly, the PoDL unit 124 separates the AC component from the communication signal input via the communication line 142 and outputs the AC component to the data I/O unit 118. The data I/O unit 118 generates digital data and outputs the generated digital data to the priority level judgment unit 110. The PoDL unit 126 separates the AC component from the communication signal input via the communication line 144, and outputs the AC component to the data I/O unit 120. The data I/O unit 120 generates digital data and outputs the digital data to the priority level judgment unit 110. This makes it possible for the priority level judgment unit 110 to receive data transmitted from the electrical devices 104, 106, and 108.

The PoDL unit 122 is connected to a PoDL unit 136 of the electrical device 104 via the communication line 140, and the superimposed signal output from the PoDL unit 122 is transmitted to the PoDL unit 136 via the communication line 140. Similarly, the PoDL unit 124 is connected to the PoDL unit of the electrical device 106 via the communication line 142, and the superimposed signal output from the PoDL unit 124 is transmitted to the PoDL unit of the electrical device 106 via the communication line 142. The PoDL unit 126 is connected to the PoDL unit of the electrical device 108 via the communication line 144, and the superimposed signal output from the PoDL unit 126 is transmitted to the PoDL unit of the electrical device 108 via the communication line 144.

### Configuration of Electrical Device

The electrical device 104 includes a control unit 130, a power reception unit 132 (power receiver), a data I/O unit 134, the PoDL unit 136, a functional unit 138, and a switch 139. The functional unit 138 is an element for realizing the function of the electrical device 104. The electrical devices 106 and 108 also include the same elements as the electrical device 104. However, functional units, which are elements for realizing the functions of the respective electrical devices 106 and 108, may be different from the functional unit 138 of the electrical device 104.

The PoDL unit 136 functions as a separation unit, similarly to the PoDL unit 122. That is, the PoDL unit 136 separates the input signal (i.e., a signal obtained by biasing the DC power from the power source unit 114) into an AC component and a DC component and outputs the AC component and the DC component. The separated AC component is input to the data I/O unit 134, and the separated DC component is input to the power reception unit 132. The PoDL unit 136 has a similar configuration to the PoDL unit 122. The PoDL unit 136 includes, for example, a bias tee. When the superimposed signal input from the communication line 140 to the PoDL unit 136 is input to the terminal T3 (see FIG. 3), the AC component is output from the terminal T1, and the DC component is output from the terminal T2. The output from the terminal T1 is input to the data I/O unit 134, and the output from the terminal T2 is input to the power reception unit 132.

The power reception unit 132 receives the DC component separated by the PoDL unit 136, that is, the DC power, and first supplies the input DC power to the data I/O unit 134 and the control unit 130. Accordingly, the control unit 130 and the data I/O unit 134 can function, and as described below, the data I/O unit 134 and the control unit 130 can receive communication signals transmitted via the communication line 140. In addition, the control unit 130 and the data I/O unit 134 can output communication signals to the communication line 140. If the power supplied from the PoDL unit 136 is sufficient to execute the function of the electrical device 104, the power reception unit 132 supplies power also to the functional unit 138, which is the element for executing the function. As described later, as a result of the communication, the control unit 130 controls the switching on/off of the switch 139 and controls the power supply from the power reception unit 132 to the functional unit 138.

The data I/O unit 134 receives input of the AC component separated by the PoDL unit 136, that is, the communication signal, generates digital data from the input communication signal, and outputs the generated digital data to the control unit 130. The data I/O unit 134 operates according to the same communication specifications as the data I/O unit 116.

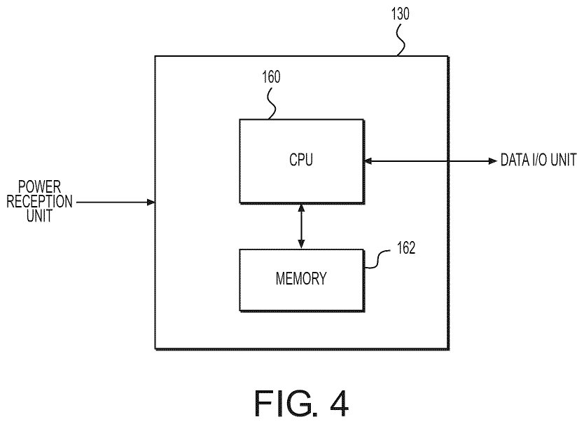

With reference to FIG. 4, the control unit 130 includes a CPU 160 and a memory 162. The CPU 160 controls the memory 162. The memory 162 is, for example, a rewritable non-volatile semiconductor memory, and stores programs to be executed by the CPU 160. The CPU 160 stores results of the executed processing in the memory 162 as appropriate. The CPU 160 outputs data input from the data I/O unit 134 to the memory 162 for storage. In addition, the CPU 160 reads out data to be output to the data I/O unit 134 from the memory 162 and outputs the data to the data I/O unit 134. If the data input from the data I/O unit 134 to the CPU 160 is an instruction to the control unit 130 (e.g., the above-mentioned transmission request), the CPU 160 executes the instructed processing and outputs the result to the data I/O unit. For example, the CPU 160 reads out information (i.e., predetermined information) that is stored in the memory 162 and indicates the function and required power of the electrical device 104, and outputs the information to the data I/O unit 134. As a result, the processing result (i.e., the predetermined information) is transmitted to the control device 102 via the communication line 140 and is received by the priority level judgment unit 110. Note that as will be described later, the information indicating the function is transmitted in order to judge the importance of the function. For example, in a vehicle, the importance of electrical devices related to the basic functions of traveling, turning, and stopping is relatively high. That is, information indicating a function is used as an example of information indicating importance.

The function of an electrical device means what the electrical device is designed to do. For example, an in-vehicle camera has an imaging function, a sensor has a sensing function, a car navigation system has a navigation function, and an entertainment device has an entertainment function. Accordingly, the information indicating the functions may be determined in advance by classifying the electrical devices that can be mounted in the vehicle according to their functions. For example, it is sufficient that a predetermined code is assigned to each of an in-vehicle camera, a sensor, and a car navigation system. In addition, even if electrical devices have the same function, if the electrical devices are used for different purposes, different codes need only be assigned according to the purposes (i.e., subdivided functions). For example, a different code can be assigned to each of a forward monitoring camera, a rear monitoring camera, a camera for an around view monitor, and an in car camera.

Each of the electrical devices 106 and 108 operates similarly to the electrical device 104. That is, each of the electrical devices 106 and 108 receives a transmission request from the priority level judgment unit 110 of the control device 102 and transmits information (i.e., predetermined information) indicating the function and required power of each of the electrical devices 106 and 108 to the control device 102. The predetermined information is received by the priority level judgment unit 110.

### Operation of Control Device

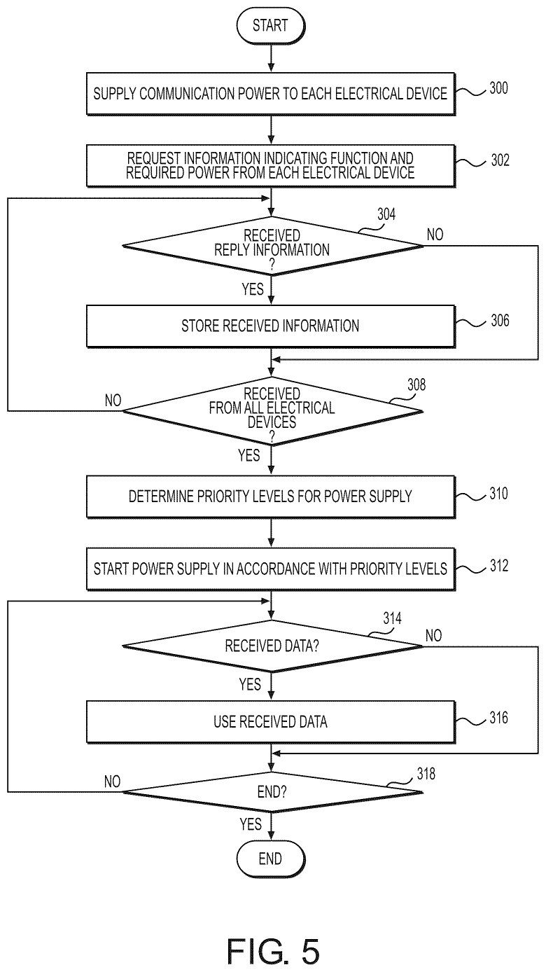

The operation of the control device 102 will be described with reference to FIG. 5. The processing shown in FIG. 5 is realized, for example, by the CPU 150 of the priority level judgment unit 110 shown in FIG. 2 reading out a corresponding program from the memory 152 and executing the program. The program is read out, for example, when the start button of the vehicle in which the in-vehicle communication system 100 is installed is turned on.

In step 300, the CPU 150 supplies communication power to each of the electrical devices 104, 106, and 108 to which power is to be supplied from the control device 102. Thereafter, the control transitions to step 302. Specifically, the CPU 150 instructs the power source control unit 112 to supply power for communication from the power source unit 114. In response to this, the power source control unit 112 instructs the power source unit 114 to output the communication power from the output port, and the power source unit 114 outputs the communication power from the output port in accordance with the instruction from the power source control unit 112. As described above, the power output from the power source unit 114 is output to the communication lines 140, 142, and 144 as superimposed signals by the PoDL units 122, 124, and 126. The superimposed signals transmitted via the communication lines 140, 142, and 144 are input to the PoDL units of the electrical devices 104, 106, and 108, and the DC components are separated and input to the power reception units. As a result, power is first supplied from the power reception unit to the data I/O unit and the control unit, and the data I/O unit and the control unit become operable. Communication power means the power required for each of the electrical devices 104, 106, and 108 to communicate with the control device 102, which is less than the power required to realize its function. The communication power can be calculated from the communication function of each electrical device mounted in the vehicle. For example, the maximum value of the calculated values for a plurality of electrical devices need only be set as the communication power and stored in advance in the memory 152.

In step 302, the CPU 150 requests information indicating the function and required power of each of the electrical devices 104, 106, and 108 from each of the electrical devices 104, 106 and 108 to which power is to be supplied by the control device 102. Thereafter, control transitions to step 304. Specifically, the CPU 150 outputs a transmission request to the data I/O units 116, 118, and 120 as described above. As a result, as described above, the PoDL units 122, 124, and 126 respectively output superimposed signals obtained by superimposing the communication signals supplied from the data I/O units 116, 118, and 120 and the power supplied from the power source unit 114, to the communication lines 140, 142, and 144. The superimposed signals transmitted via the communication lines 140, 142, and 144 are input to the PoDL units of the electrical devices 104, 106, and 108 and are each separated into a DC component and an AC component. The DC component is input to the power reception unit, power is supplied from the power reception unit to the data I/O unit and the control unit, and thus the data I/O unit and the control unit are maintained in an operable state. The AC component is input to the data I/O unit and converted into digital data, and the digital data is input to the control unit. This makes it possible for the control unit of each of the electrical devices 104, 106, and 108 to receive the transmission request transmitted from the control device 102.

In step 304, the CPU 150 judges whether or not reply information to the transmission request transmitted in step 302 has been received. The reply information is information indicating the function and the required power (i.e., predetermined information). If it is judged that the reply information has been received, the control transitions to step 306. If not, the control transitions to step 308.

In step 306, the CPU 150 stores the data received in step 304 (i.e., the reply information) in the memory 152. Thereafter, the control transitions to step 308.

In step 308, the CPU 150 judges whether or not reply information has been received from all of the electrical devices 104, 106, and 108 to which power is to be supplied from the control device 102. If it is judged that the reply information has been received, the control transitions to step 310. If not, the control returns to step 304, and waits for the reply information from the electrical devices.

In step 310, the CPU 150 reads out the return information (i.e., information indicating functions and required power) stored in the memory 152 in step 306, and determines the priority levels for supplying power from the control device 102 based on the functions and required power. The priority levels include a priority ranking. For example, if the reply information indicates that the electrical device 104 is an object detection camera, the electrical device 106 is a car navigation system, and the electrical device 108 is an entertainment device, the CPU 150 can determine the priority ranking (i.e., priority levels) such that the electrical device 104 has the highest priority level, and the priority levels decrease in the order of the electrical devices 104, 106, and 108. For example, if the sum of the required power of the electrical devices 104, 106, and 108 exceeds the maximum output of the power source unit 114, power is supplied to the electrical devices 104, 106, and 108 in the stated order, within the range of the maximum output of the power source unit 114.

In step 312, the CPU 150 starts power supply from the power source unit 114 to the electrical devices 104, 106, and 108 according to the priority levels determined in step 310. Specifically, as described above, the CPU 150 outputs the priority level information to the power source control unit 112. As a result, the power source control unit 112 outputs output power information to the power source unit 114 in accordance with the priority level information input from the priority level judgment unit 110. The power source unit 114 outputs power (i.e., DC power) from each output port in accordance with the output power information input from the power source control unit 112. The output power of the power source unit 114 is input to the PoDL units 122, 124, and 126 and is supplied to the electrical devices 104, 106, and 108 via the communication lines 140, 142, and 144.

In step 314, the CPU 150 judges whether or not data has been received from the electrical device that is being supplied with power. If it is judged that the data has been received, the control transitions to step 316. If not, the control transitions to step 318.

In step 316, the CPU 150 outputs the data received in step 314 to the corresponding device. Thereafter, the control transitions to step 318. For example, data from an object detection camera is output to an automatic driving electronic control unit (ECU). The automatic driving ECU analyzes the output data from the object detection camera to ascertain the situation in the surrounding area of the vehicle and controls mechanisms related to automatic driving (engine, transmission, steering, brakes, etc.).

In step 318, the CPU 150 judges whether or not an end instruction has been received. If it is judged that an end instruction has been received, the program ends. If not, the control transitions to step 314. The end instruction is issued, for example, by turning off the start button of the vehicle in which the in-vehicle communication system 100 is mounted.

### Operation of Electrical Devices

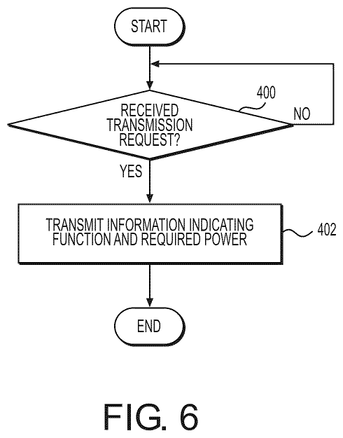

The operation of the electrical devices 104, 106, and 108 will now be described. The operation of the electrical devices 104, 106, and 108 is the same. Here, the operation of the electrical device 104 will be described with reference to FIG. 6. The processing shown in FIG. 6 is realized by the CPU 160 of the control unit 130 shown in FIG. 4 reading out a corresponding program from the memory 162 and executing it. This program is read out when power for communication is supplied from the power source unit 114 of the control device 102 to the electrical device 104 in step 300 shown in FIG. 5 and the control unit 130 becomes operable.

In step 400, the CPU 160 judges whether or not a transmission request has been received. If it is judged that the transmission request has been received, the control transitions to step 402. If not, step 400 is repeated.

In step 402, the CPU 160 transmits information indicating the function and required power of the electrical device 104 to the control device 102. Specifically, as described above, the CPU 160 reads out the information indicating the function and required power of the electrical device 104 from the memory 162 and outputs the information to the data I/O unit 134. As a result, the information indicating the function and required power is transmitted as reply information to the transmission request from the control device 102 (specifically, the priority level judgment unit 110). Thereafter, the program ends.

After transmitting the reply information to the control device 102, the electrical device 104 executes the function of the electrical device 104 if the control device 102 has supplied the electrical device 104 with enough power to perform the function of the electrical device 104 (i.e., power corresponding to the required power). That is, the CPU 160 of the control unit 130 turns on the switch 139, which is off in the initial state, and power for executing the function of the electrical device 104 is supplied from the power reception unit 132 to the functional unit 138. On the other hand, if the priority level of the electrical device 104 is low and power is not supplied from the control device 102 to the electrical device 104 after the reply information is transmitted to the control device 102, the electrical device 104 cannot be started up. That is, the switch 139 remains off.

As described above, it is possible to determine the priority levels for a plurality of electrical devices mounted in a vehicle, and to supply power based on the determined priority levels. For example, if the priority levels are determined according to the importance of each electrical device, power can be supplied preferentially to an electrical device having a specific function based on the importance of each electrical device.

As described above, the control device 102 supplies communication power that enables each electrical device to communicate with the control device 102 when power is not being supplied to each electrical device. This makes it possible to suppress unnecessary power consumption.

As described above, the control device 102 includes the PoDL units 122, 124, and 126 that superimpose the DC power from the power source unit 114 on the communication signals from the data I/O units 116, 118, and 120, and output the superimposed signals. This makes it possible for the control device 102 to supply DC power to the electrical devices 104, 106, and 108 by superimposing the DC power onto the communication lines 140, 142, and 144 that transmit communication signals. Accordingly, the number of electrical wirings can be reduced.

As described above, each electrical device includes a PoDL unit having the function of separating a communication signal from a superimposed signal transmitted via a communication line, and a data I/O unit having a communication function of transmitting information indicating the importance (specifically, the function) and required power of the electrical device to the control device 102 via the communication line in response to the separated transmission request. This makes it possible for the control device 102 to receive information indicating the importance (specifically, the function) and required power of each of a plurality of electrical devices, whereby it is possible to judge the priority levels.

As described above, the PoDL unit of each electrical device separates DC power from the superimposed signal transmitted via the communication line, and each electrical device includes a power reception unit that first supplies the separated DC power to a data I/O unit having a communication function. This makes it possible for each electrical device to transmit information indicating the importance (specifically, the function) and required power of each electrical device in response to a transmission request from the control device 102.

In the description above, a case has been described in which the program shown in FIG. 5 is executed when the start button of the vehicle in which the in-vehicle communication system 100 is mounted is turned on, but there is no limitation to this. If the configuration of the electrical devices mounted in the vehicle has not been changed, the CPU 150 need only execute steps 300 to 308 in FIG. 5 once. Since the memory 152 stores the function and required power of each electrical device, the CPU 150 may read out the stored data and determine the priority levels the next time or later.

### First Variation

The importance of each electrical device installed in the vehicle changes depending on the state of the vehicle. Accordingly, the in-vehicle communication system according to the first variation judges the priority levels according to the state of the vehicle in which the in vehicle communication system is mounted.

The configuration of the in vehicle communication system according to the first variation is the same as that shown in FIGS. 1 to 4. The difference is the processing related to the priority level judgment in the control device 102. Accordingly, in the following, the differences will be mainly described with reference to the symbols in FIGS. 1 to 4, without repeating redundant description.

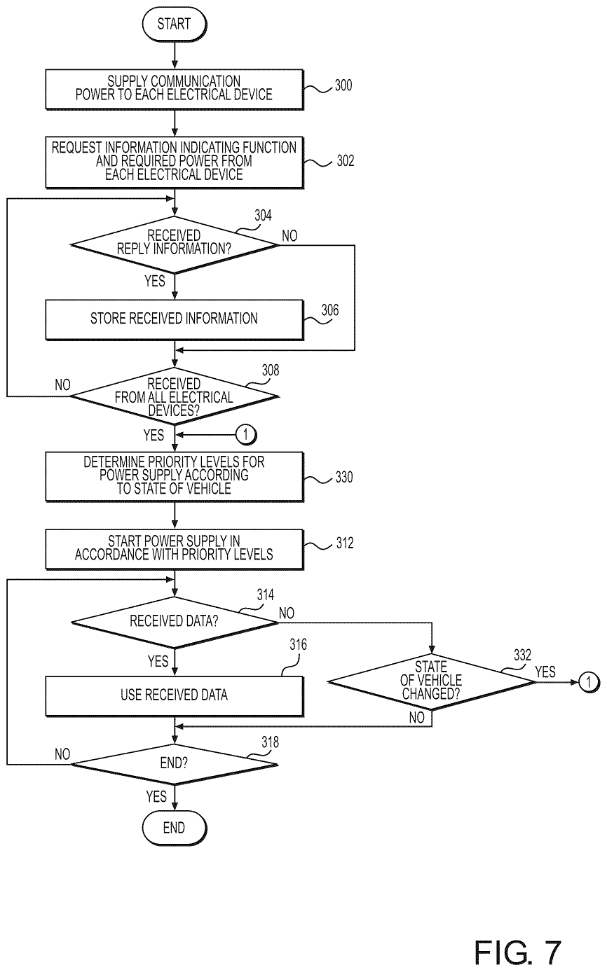

The operation of the control device 102 according to the first variation will be described with reference to FIG. 7. The processing shown in FIG. 7 is realized, similarly to that in FIG. 5, by the CPU 150 of the priority level judgment unit 110 shown in FIG. 2 reading out a corresponding program from the memory 152 and executing it when, for example, the start button of the vehicle in which the in-vehicle communication system 100 is mounted is turned on. The flowchart shown in FIG. 7 is the same as the flowchart shown in FIG. 5, except that step 310 is replaced by step 330 and step 332 is added.

Similarly to FIG. 5, in steps 300 through 308, the CPU 150 acquires information indicating the respective functions and required power of the electrical devices 104, 106, and 108 from the electrical devices 104, 106, and 108. Thereafter, in step 330, the CPU 150 reads out the reply information (i.e., information indicating the functions and required power) stored in the memory 152, and determines the priority level of supplying power from the control device 102 based on the functions and required power and the current state of the vehicle in which the in vehicle communication system 100 is mounted. The state of the vehicle includes, for example, a parking operation and normal travel. The CPU 150 can specify the state of the vehicle using output data from various sensors (such as a camera and an acceleration sensor) mounted in the vehicle, position information from a global positioning system (GPS), and the like.

For example, it is assumed that the reply information indicates that the electrical device 104 is a front camera for object detection, the electrical device 106 is a rear camera for object detection, and the electrical device 108 is a camera for an around view monitor. During normal travel, the CPU 150 determines the priority levels such that the electrical device 104 has the highest priority, and the priority levels decrease in the order of the electrical devices 104, 106, and 108. During a parking operation, the CPU 150 determines the priority levels such that the electrical device 108 has the highest priority level, and the priority levels decrease in the order of the electrical devices 108, 106, and 104. During normal travel, the front camera for object detection and the rear camera for object detection are important, but the camera for the around view monitor is not important. On the other hand, during a parking operation, the around view monitor camera is the most important, and the front camera for object detection and the rear camera for object detection are less important.

Thereafter, power supply is started in step 312 according to the priority levels determined in step 330. If it is judged in the following step 314 that no data has been received, the CPU 150 judges in step 332 whether or not the state of the vehicle has changed. If it is judged that the state of the vehicle has changed, the control returns to step 330, and new priority levels are determined based on the current state of the vehicle and the reply information, as described above. If not, the control transitions to step 318.

This makes it possible for the control device 102 to determine appropriate priority levels according to the state of the vehicle. The importance of each of the electrical devices mounted in the vehicle changes depending on the state of the vehicle. Accordingly, power can be supplied preferentially to electrical devices having specific functions according to the state of the vehicle.

Note that the vehicle state also includes a state in which the function of the electrical device has been turned off by a user. In this case, the priority level may be changed such that the priority level of power supply to the electrical device having the function that has been instructed to be turned off is given the lowest priority level. For example, the user can turn off an automatic driving function (e.g., an automatic following driving function, etc.). When turned off, sensors, radar, and the like that are used solely for that function do not require power supply.

### Second Embodiment

In the above description, a case has been described in which one control device supplies power to a plurality of electrical devices. However, in the second embodiment, some electrical devices can receive a supply of power from a plurality of control devices.

### Overall Composition

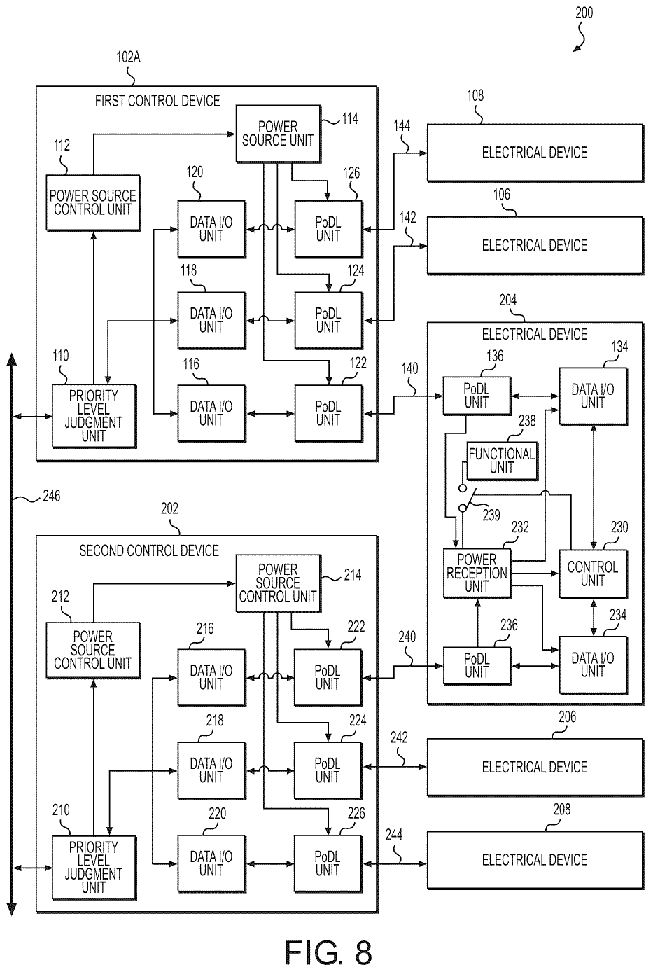

Referring to FIG. 8, an in-vehicle communication system 200 according to the second embodiment of the present disclosure includes a first control device 102A, electrical devices 106 and 108, a second control device 202, a specific electrical device 204, and electrical devices 206 and 208. The in-vehicle communication system 200 is mounted in a vehicle (not shown). The in-vehicle communication system 200 is the same as the in-vehicle communication system 100 shown in FIG. 1, except that the electrical device 104 is replaced with a specific electrical device 204, and a second control device 202 and electrical devices 206 and 208 are added. The first control device 102A is the same as the control device 102 described in the first embodiment, but a different reference numeral and a different name are used for convenience.

The first control device 102A is, for example, a C-ECU. The specific electrical device 204 and the electrical devices 106 and 108 are supplied with power from the first control device 102A. The first control device 102A is communicably connected to the specific electrical device 204 and the electrical devices 106 and 108 by communication lines 140, 142, and 144, respectively. The second control device 202 is, for example, a zone electronic control unit (Z-ECU). The specific electrical device 204 and the electrical devices 206 and 208 are supplied with power from the second control device 202. The second control device 202 is communicably connected to the specific electrical device 204 and the electrical devices 206 and 208 by communication lines 240, 242, and 244, respectively. The specific electrical device 204 and each of the electrical devices 106, 108, 206, and 208 may be in-vehicle cameras, sensors, car navigation systems, or the like. Unlike the electrical devices 106, 108, 206, and 208, the specific electrical device 204 is connected to the first control device 102A and the second control device 202 and can be supplied with power by the first control device 102A and the second control device 202. The first control device 102A and the second control device 202 are connected to a bus 246. The bus 246 is, for example, a control device area network (CAN).

Note that in FIG. 8, each of the first control device 102A and the second control device 202 is connected to three electrical devices so as to be able to supply power thereto, but there is no limitation to this. Each of the first control device 102A and the second control device 202 may also be electrically connected to two electrical devices so as to be able to supply power thereto. In addition, each of the first control device 102A and the second control device 202 may be connected to four or more electrical devices so as to be able to supply power thereto. In addition, in FIG. 8, one specific electrical device 204 is connected to the first control device 102A and the second control device 202, but there is no limitation to this. Two or more electrical devices may also be connected to the first control device 102A and the second control device 202.

### Configuration of Second Control Device

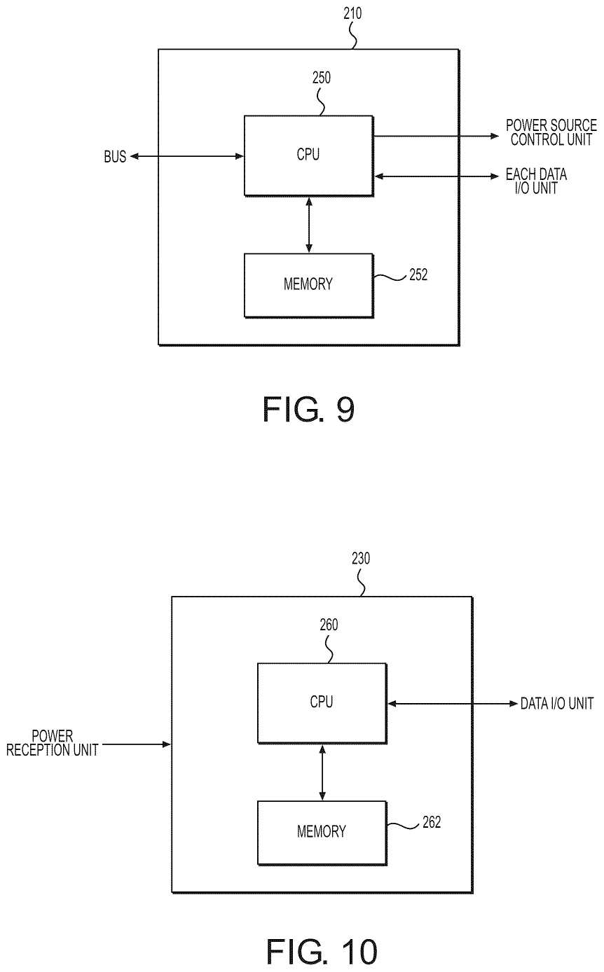

The second control device 202 includes a priority level judgment unit 210, a power source control unit 212, a power source unit 214, data I/O units 216, 218, and 220, and PoDL units 222, 224, and 226. With reference to FIG. 9, the priority level judgment unit 210 includes a CPU 250 and a memory 252. The CPU 250 controls the memory 252. The memory 252 is, for example, a rewritable non-volatile semiconductor memory, and stores the programs to be executed by the CPU 250. The CPU 250 stores the results of the executed processing in the memory 252 as appropriate. The CPU 250 outputs data input from the data I/O units 216, 218, and 220 to the memory 252 for storage. In addition, the CPU 250 reads out, from the memory 252, data to be output from the priority level judgment unit 210 to the power source control unit 212 and the data I/O units 216, 218, and 220, and outputs the data.

The priority level judgment unit 210 judges the priority levels for supplying power from the second control device 202 to the specific electrical device 204 and the electrical devices 206 and 208, and outputs priority level information indicating the priority levels determined through the judgment to the power source control unit 212. The power source control unit 212 outputs, to the power source unit 214, output power information instructing the values of the power to be output from the plurality of ports of the power source unit 214 in accordance with the priority level information input from the priority level judgment unit 210. The power source unit 214 outputs power (i.e., DC power) of an instructed magnitude from each output port in accordance with the output power information input from the power source control unit 212. The three output ports of the power source unit 214 are connected to the PoDL units 222, 224, and 226, respectively, and the output power of the power source unit 214 is input to the PoDL units 222, 224, and 226. Note that as described below, when the first control device 102A is supplying power to the specific electrical device 204, the power source unit 214 does not supply power to the PoDL unit 222 (i.e., no power is supplied from the second control device 202 to the specific electrical device 204).

The priority level judgment unit 210 acquires, from the electrical devices 206 and 208, predetermined information for judging the above mentioned priority levels. To this end, the priority level judgment unit 210 outputs a transmission request to the data I/O units 218 and 220, requesting predetermined information (i.e., information indicating the functions and required power of the electrical devices). The data I/O units 218 and 220 output communication signals corresponding to the transmission requests input from the priority level judgment unit 210. The data I/O units 218 and 220 are connected to the PoDL units 224 and 226, respectively, and communication signals (i.e., transmission requests) output from the data I/O units 218 and 220 are input to the PoDL units 224 and 226.

Each of the PoDL units 222, 224, and 226 functions as a signal superimposing unit. That is, the PoDL unit 222 generates a superimposed signal by superimposing the communication signal input from the data I/O unit 216 and the DC power input from the power source unit 214, and outputs the superimposed signal to the communication line 240. The PoDL unit 224 superimposes a communication signal (e.g., a transmission request) input from the data I/O unit 218 on the DC power input from the power source unit 214, and outputs the superimposed signal to the communication line 242. The PoDL unit 226 superimposes a communication signal (e.g., a transmission request) input from the data I/O unit 220 on the DC power input from the power source unit 214, and outputs the superimposed signal to the communication line 244. Each of the PoDL units 222, 224, and 226 includes, for example, a bias tee.

In addition, each of the PoDL units 222, 224, and 226 functions also as a signal separation unit. That is, the PoDL unit 222 separates the AC component from the communication signal input via the communication line 240 (i.e., the signal obtained by biasing the DC power from the power source unit 214) , and outputs the separated AC component to the data I/O unit 216. The data I/O unit 216 generates digital data and outputs the digital data to the priority level judgment unit 210. Similarly, the PoDL unit 224 separates the AC component from the communication signal input via the communication line 242 and outputs the separated AC component to the data I/O unit 218. The data I/O unit 218 generates digital data and outputs the digital data to the priority level judgment unit 210. The PoDL unit 226 separates the AC component from the communication signal input via the communication line 244, and outputs the separated AC component to the data I/O unit 220. The data I/O unit 220 generates digital data and outputs the digital data to the priority level judgment unit 210.

The PoDL unit 222 is connected to a PoDL unit 236 of the specific electrical device 204 via a communication line 240, and the superimposed signal output from the PoDL unit 222 is transmitted to the PoDL unit 236 via the communication line 240. Similarly, the PoDL unit 224 is connected to the PoDL unit of the electrical device 206 via a communication line 242, and the superimposed signal output from the PoDL unit 224 is transmitted to the PoDL unit of the electrical device 206 via the communication line 242. The PoDL unit 226 is connected to the PoDL unit of the electrical device 208 via a communication line 244, and the superimposed signal output from the PoDL unit 226 is transmitted to the PoDL unit of the electrical device 208 via the communication line 244.

### Configuration of Electrical Device

The specific electrical device 204 includes a control unit 230, a power reception unit 232, data I/O units 134 and 234, PoDL units 136 and 236, a functional unit 238, and a switch 239. The functional unit 238 is an element for realizing the function of the specific electrical device 204. The electrical devices 206 and 208 include the same elements as the electrical device 104 shown in FIG. 1. However, the functional units, which are elements for realizing the respective functions of the electrical devices 206 and 208 and are not shown in the drawings, may be different from the functional unit 138 of the electrical device 104.

The data I/O unit 134 and the PoDL unit 136 function as described with respect to the electrical device 104 shown in FIG. 1. That is, the PoDL unit 136 functions as a separation unit, and separates the input signal into an AC component and a DC component and outputs the AC component and the DC component. The separated AC component is input to the data I/O unit 134, and the separated DC component is input to the power reception unit 232. The data I/O unit 134 receives input of the AC component separated by the PoDL unit 136, that is, the communication signal, generates digital data from the input communication signal, and outputs the digital data to the control unit 230.

The PoDL unit 236 functions as a separator, similarly to the PoDL unit 136. That is, the PoDL unit 236 separates the input signal into an AC component and a DC component and outputs the AC component and the DC component. The separated AC component is input to the data I/O unit 234, and the separated DC component is input to the power reception unit 232. The PoDL unit 236 has the same configuration as the PoDL unit 122 (see FIG. 3). The PoDL unit 236 includes, for example, a bias tee.

The power reception unit 232 receives input of the DC component separated by the PoDL unit 136, that is, the DC power, and first supplies the input power to the data I/O unit 134 and the control unit 230. Accordingly, the control unit 230 and the data I/O unit 134 can function, and the data I/O unit 134 and the control unit 230 can receive a communication signal (e.g., a transmission request) transmitted from the first control device 102A via the communication line 140. In addition, the control unit 230 and the data I/O unit 134 can output a communication signal to the communication line 140 via the PoDL unit 136. If the power supplied from the PoDL unit 136 is sufficient to execute the function of the electrical device 104, the power reception unit 232 supplies power also to a functional unit 238 that is an element for executing the function. That is, the control unit 230 controls the switching on/off of the switch 239, and controls the power supply from the power reception unit 232 to the functional unit 238.

For example, when the second control device 202 requires data output from the specific electrical device 204, the power reception unit 232 supplies the power supplied from the first control device 102A to the data I/O unit 234 as well. For example, it is assumed that the specific electrical device 204 is a forward camera for object detection, the first control device 102A outputs image data from the specific electrical device 204 to an automatic driving ECU, and the second control device 202 outputs image data from the specific electrical device 204 to a recording device. In this case, power from the first control device 102A is supplied to the data I/O unit 234 as well. On the other hand, if the second control device 202 does not need the data output from the specific electrical device 204, the power reception unit 232 does not need to supply power to the data I/O unit 234.

With reference to FIG. 10, the control unit 230 includes a CPU 260 and a memory 262. The CPU 260 controls the memory 262. The memory 262 is, for example, a rewritable non-volatile semiconductor memory, and stores programs to be executed by the CPU 260. The CPU 260 stores the results of the executed processing in the memory 262 as appropriate. The CPU 260 outputs data input from the data I/O unit 134 or 234 to the memory 262 for storage. In addition, the CPU 260 reads out data to be output to the data I/O unit 134 or 234 from the memory 262 and outputs the data to the data I/O unit 134 or 234.

If power is being supplied from the first control device 102A and the data input from the data I/O unit 134 to the control unit 230 (i.e., CPU 260) is an instruction (e.g., a transmission request) to the control unit 230, the CPU 260 executes the instructed processing and outputs the result to the data I/O unit 134. For example, the CPU 260 reads out information (i.e., predetermined information) that is stored in the memory 262 and indicates the function and required power of the specific electrical device 204, and outputs the information to the data I/O unit 134. As a result, the processing result (i.e., the predetermined information) is transmitted to the first control device 102A via the communication line 140, and is received by the priority level judgment unit 110.

When power is being supplied from the second control device 202, if the data input from the data I/O unit 234 to the control unit 230 (i.e., the CPU 260) is an instruction for the control unit 230, the CPU 260 executes the instructed processing and outputs the result to the data I/O unit 234. As a result, the processing result is transmitted to the second control device 202 via the communication line 240 and is received by the priority level judgment unit 210.

Each of the electrical devices 206 and 208 operates similarly to the electrical device 104 shown in FIG. 1. However, the electrical device 104 is connected to the control device 102, whereas the electrical devices 206 and 208 are connected to the second control device 202. Accordingly, the electrical devices 206 and 208 receive a transmission request from the priority level judgment unit 210 of the second control device 202 and transmit information indicating the functions and required power of the electrical devices 206 and 208 to the second control device 202.

### Operation of First Control Device

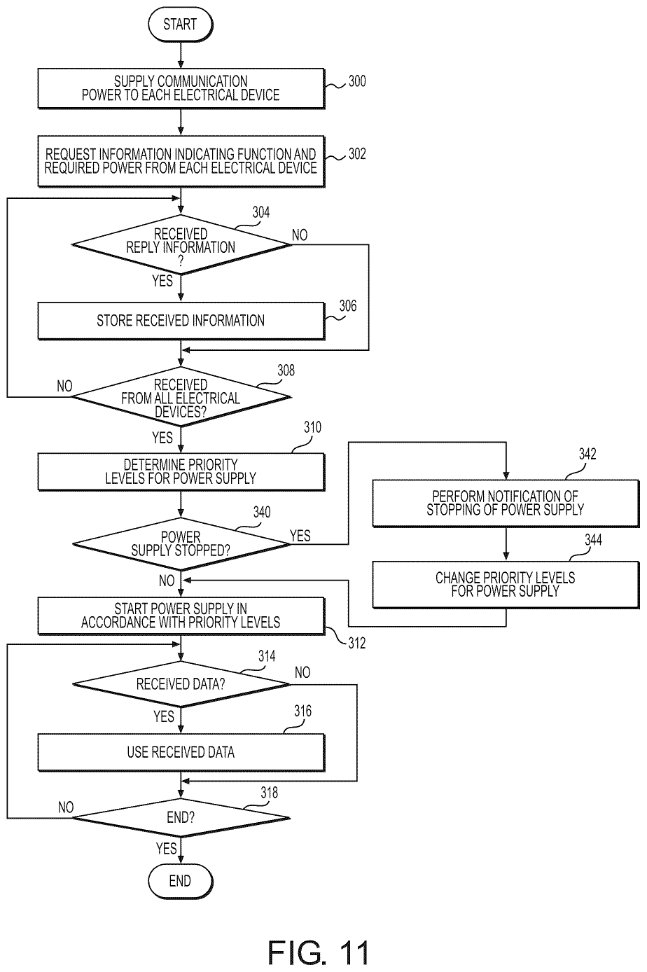

The operation of the first control device 102A will be described with reference to FIG. 11. The processing shown in FIG. 11 is realized, for example, by the CPU 150 of the priority level judgment unit 110 shown in FIG. 2 reading out a corresponding program from the memory 152 and executing the program. The program is read out, for example, when the start button of the vehicle in which the in vehicle communication system 200 is mounted is turned on. Note that as described above, the first control device 102A is connected to the bus 246, and the CPU 150 of the priority level judgment unit 110 shown in FIG. 8 is connected to the bus 246 in the same manner as the CPU 250 shown in FIG. 9. The flowchart shown in FIG. 11 is the same as the flowchart shown in FIG. 5, except that steps 340, 342, and 344 have been added. Accordingly, redundant description will not be repeated and the following mainly describes the differences.

Similarly to FIG. 5, in steps 300 to 310, the CPU 150 acquires information indicating the respective functions and required power from the specific electrical device 204 and the electrical devices 106 and 108, and determines the priority levels for supplying power. Next, in step 340, the CPU 150 judges whether or not to stop power supply to the specific electrical device 204. If it is judged that power supply is to be stopped, the control transitions to step 342. If not, the control transitions to step 312.

In step 342, the CPU 150 reads information (i.e., specified information) indicating the function and required power of the specific electrical device 204 for which power supply is to be stopped from the memory 152, generates information indicating stopping of the power supply (hereinafter referred to as stop information) including the specified information, and notifies the second control device 202 via the bus 246. The stop information is received by the priority level judgment unit 210 (specifically, the CPU 250) of the second control device 202. Stopping the power supply includes a case where the first control device 102A is scheduled to stop the power supply, and a case where power supply cannot be performed due to, for example, the communication line 140 being cut off. The inability to perform power supply can be detected, for example, by the CPU 150 periodically communicating with the control unit 230 of the specific electrical device 204 while the first control device 102A is supplying power. If the CPU 150 cannot communicate with the control unit 230 of the specific electrical device 204, the CPU 150 can judge that the communication line 140 has been cut off. If the power supply is scheduled to be stopped, the CPU 150 waits for a predetermined amount of time, and then the control transitions to step 344. The reason for waiting for the predetermined amount of time is to ensure that power can be supplied without interruption from the second control device 202 to the specific electrical device 204, as will be described later. If power supply cannot be performed, the control immediately transitions to step 344.

In step 344, the CPU 150 changes the current priority levels. That is, since the power supply to the specific electrical device 204 is scheduled to be stopped or the power supply to the specific electrical device 204 has already been stopped, the CPU 150 determines new priority levels excluding the specific electrical device 204. Thereafter, control transitions to step 312, and the CPU 150 starts supplying power to the electrical devices according to the new priority levels. That is, the power supply from the power source unit 114 of the first control device 102A to the specific electrical device 204 is stopped.

### Operation of Second Control Device

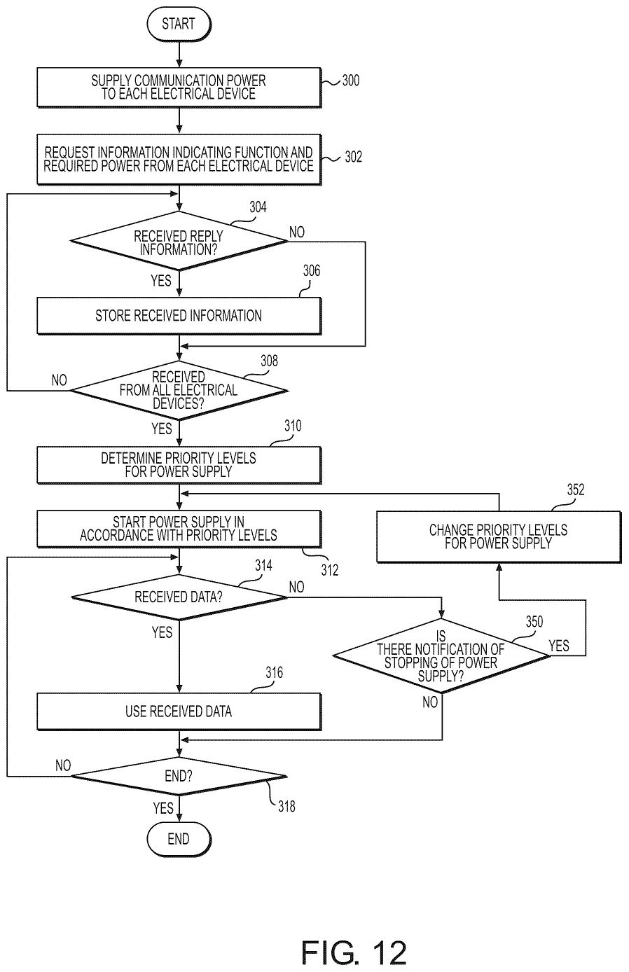

Operation of the second control device 202 will be described with reference to FIG. 12. The processing shown in FIG. 12 is realized, for example, by the CPU 250 of the priority level judgment unit 210 shown in FIG. 9 reading out a corresponding program from the memory 252 and executing the program. The program is read out, for example, when the start button of the vehicle in which the in vehicle communication system 200 is mounted is turned on. The flowchart shown in FIG. 12 is the same as the flowchart shown in FIG. 5, except that steps 350 and 352 are added. Accordingly, redundant description will not be repeated and the following mainly describes the differences.

Similarly to FIG. 5, in steps 300 to 312, the CPU 250 acquires information indicating the respective functions and required power from the electrical devices 206 to 208, determines priority levels for supplying power, and starts supplying power in accordance with the determined priority levels. At this stage, as described above, power is being supplied to the specific electrical device 204 from the first control device 102A, and power is not supplied from the second control device 202 to the specific electrical device 204. Accordingly, the priority levels do not include the specific electrical device 204 because the CPU 250 has not transmitted a transmission request to the specific electrical device 204 and has not received information indicating the function and required power from the specific electrical device 204.

Next, if it is judged in step 314 that no data has been received, in step 350, the CPU 250 judges whether or not there is a notification to stop the power supply from the first control device 102A to the specific electrical device 204. Specifically, the CPU 250 judges whether or not the stop information has been received from the first control device 102A. If it is judged that there is a notification to stop, the control transitions to step 352. If not, the control transitions to step 318. The stop information is transmitted from the CPU 150 in step 342 shown in FIG. 11.

In step 352, the CPU 250 changes the current priority levels. That is, since the CPU 250 starts supplying power to the specific electrical device 204, the CPU 250 determines new priority levels including the specific electrical device 204, that is, by referring to the functions and required power of the specific electrical device 204 included in the stop information. Although it is not necessary to determine the new priority levels such that the specific electrical device 204 has the highest priority level, the new priority levels are determined such that the specific electrical device 204 is supplied with power. Thereafter, the control transitions to step 312, and power supply from the power source unit 214 of the second control device 202 is started in accordance with the new priority levels.

As a result, when the power supply from the first control device 102A to the specific electrical device 204 is stopped, the power supply from the second control device 202 to the specific electrical device 204 can be performed, and the specific electrical device 204 can maintain its function. For example, it is assumed that the specific electrical device 204 is a forward camera for object detection, the first control device 102A outputs image data from the specific electrical device 204 to an automatic driving ECU, and the second control device 202 outputs image data from the specific electrical device 204 to a recording device. During normal vehicle travel, the first control device 102A supplies power to the specific electrical device 204 since data from the specific electrical device 204 is required. However, during a parking operation of the vehicle, the first control device 102A does not need data from the specific electrical device 204, and therefore power supply to the specific electrical device 204 is stopped. On the other hand, the specific electrical device 204 needs data from the specific electrical device 204 as recording data also during a parking operation of the vehicle. Accordingly, the power supply state is changed such that power is supplied from the second control device 202 to the specific electrical device 204. In addition, if the communication line 140 is cut off as described above, power cannot be supplied from the first control device 102A to the specific electrical device 204, and the specific electrical device 204 will no longer function. By supplying power from the second control device 202 to the specific electrical device 204, the specific electrical device 204 continues to function, and output data from the specific electrical device 204 is transmitted to the second control device 202.

As described above, the priority level judgment unit 110 (specifically, CPU 150) of the first control device 102A performs notification of the stop information to the priority level judgment unit 210 (specifically, CPU 250) of the second control device 202 via the bus 246. This enables the second control device 202 to efficiently start supplying power to the specific electrical device 204 when the power supply from the first control device 102A to the specific electrical device 204 is stopped.

As described above, the stop information notified from the first control device 102A to the second control device 202 includes information indicating the function and required power of the specific electrical device 204. This enables the second control device 202 to quickly change the priority levels such that power can be supplied to the specific electrical device 204.

Note that the first control device 102A may notify the second control device 202 of stop information that does not include information indicating the function and required power of the specific electrical device 204. In this case, upon receiving the stop information from the first control device 102A, the second control device 202 transmits a transmission request from the data I/O unit 216 to the specific electrical device 204 via the PoDL unit 222 and the communication line 240. Since there are also cases where power is not being supplied from the first control device 102A to the specific electrical device 204 due to a break in the communication line 140, or the like, the second control device 202 may supply communication power from the power source unit 214 via the PoDL unit 222 and the communication line 240 to the specific electrical device 204, and transmit a transmission request from the data I/O unit 216 via the communication line 240. This enables the second control device 202 to acquire information indicating the function and required power of the specific electrical device 204 and change the priority level such that power can be supplied to the specific electrical device 204.

In addition, when the first control device 102A stops the power supply to the specific electrical device 204, in addition to the stop information, information indicating the amount time (e.g., in seconds) until the power supply to the specific electrical device 204 is stopped may also be transmitted from the first control device 102A to the second control device 202. This enables the second control device 202 to start supplying power to the specific electrical device 204 at the same time that the power supply from the first control device 102A to the specific electrical device 204 is stopped, such that the power supply to the specific electrical device 204 is not interrupted.

In the above description, a case has been described in which the first control device 102A is a C-ECU and the second control device 202 is a Z-ECU, but there is no limitation to this. The first control device 102A may also be a Z-ECU separate from the second control device 202.

### Second Variation

In the above description, a case has been described in which the first control device 102A notifies the second control device 202 of the stop information before stopping the power supply from the first control device 102A to the specific electrical device 204, but there is no limitation to this. In the second variation, the first control device 102A notifies the specific electrical device 204 of the stop information, and the specific electrical device 204 requests the second control device 202 to supply power. The configuration of the in-vehicle communication system according to the second variation is the same as that in FIG. 8. However, since the first control device 102A does not notify the second control device 202 of the stop information, the bus 246 need not be provided.

### Operation of First Control Device

In the second variation, the priority level judgment unit 110 of the first control device 102A (specifically, the CPU 150 shown in FIG. 2) need only notify the specific electrical device 204 of the stop information via the communication line 140 in step 342 of FIG. 11. The stop information notified at this time does not include information indicating the functions and required power.

### Operation of Electrical Device

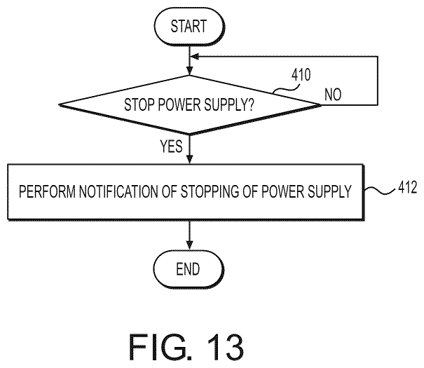

The operation of the specific electrical device 204 will now be described with reference to FIG. 13. The processing shown in FIG. 13 is realized by the CPU 260 of the control unit 230 shown in FIG. 10 reading out a corresponding program from the memory 262 and executing it. This program is read out when communication power is supplied from the power source unit 114 of the first control device 102A to the specific electrical device 204 in step 300 shown in FIG. 11 and the control unit 230 becomes operable.

In step 410, the CPU 260 judges whether or not the power supply is to be stopped. Specifically, the CPU 260 judges whether or not the stop information has been notified from the first control device 102A. If it is judged that the power supply is to be stopped, the control transitions to step 412. If not, step 410 is repeated.

In step 412, the CPU 260 notifies the second control device 202 that the power supply from the first control device 102A is to be stopped. Specifically, the CPU 260 reads out information indicating its own function and required power (i.e., predetermined information) from the memory 262, generates stop information including the predetermined information, and notifies the second control device 202 of the stop information via the communication line 240. Thereafter, the program ends.

### Operation of Second Control Device

In the second variation, the priority level judgment unit 210 (specifically, the CPU 250) of the second control device 202 need only execute the same program as that shown in FIG. 12. That is, when the CPU 250 receives the stop information via the communication line 240 in step 350, the CPU 250 determines new priority levels in step 352 by referring to the information indicating the functions and required power included in the stop information.

As a result, when the power supply from the first control device 102A to the specific electrical device 204 is stopped, the power supply from the second control device 202 to the specific electrical device 204 can be performed, and the specific electrical device 204 can maintain its function. As described above, in response to the specific electrical device 204 receiving a notification from the first control device 102A that the power supply is to be stopped, the specific electrical device 204 transmits the stop information to the second control device 202, whereby the second control device 202 can efficiently start supplying power to the specific electrical device 204.

As described above, the stop information notified from the specific electrical device 204 to the second control device 202 includes information indicating the function and required power of the specific electrical device 204. This enables the second control device 202 to quickly change the priority levels such that power can be supplied to the specific electrical device 204.

In the above description, a case has been described in which the power supply from the first control device 102A to the specific electrical device 204 is stopped and power is supplied from the second control device 202 to the specific electrical device 204, but there is no limitation to this. When the power supplied from the first control device 102A to the specific electrical device 204 is reduced, the second control device 202 may supply the power that is insufficient in the specific electrical device 204. In this case, if the second control device 202 can receive information indicating that the power is to be reduced, similarly to the stop information, the second control device 202 can start supplying power to the specific electrical device 204 in the same manner as described above. If the second control device 202 can receive information on the power that is insufficient in the specific electrical device 204 from the first control device 102A or the specific electrical device 204, the second control device 202 can supply an appropriate amount of power. Note that reducing the power supplied from the first control device 102A to the specific electrical device 204 includes setting the supplied power to zero, that is, stopping the power supply from the first control device 102A.

In the above description, a case was described in which the control device has a PoDL unit corresponding to each electrical device to which power is to be supplied, but there is no limitation to this. The control device does not need to have a PoDL unit. The control device may also include at least one PoDL unit. Power may also be supplied to some or all of the plurality of electrical devices to which power is to be supplied, via a path other than the communication line without going through a PoDL unit, that is, without superimposing the power and the communication signal.

In the above description, a case was described in which the power supplied from the power source unit is DC power, but there is no limitation to this. AC power may also be supplied from a power source unit. If the electrical device is a device that operates on AC power, the AC power and the communication signal need only be superimposed and supplied to the electrical device. The superimposition and separation of the AC power and the communication signal can be performed by, for example, PLC (Power Line Communication).

Note that each process (each function) in the above-described embodiment may also be realized by a processing circuit (circuitry) including one or more processors. The priority level judgment unit may also be constituted by an integrated circuit in which, in addition to one or more processors, one of the following is combined: one or more memories, various analog circuits, and various digital circuits. The one or more memories store programs (commands) for causing the one or more processors to execute each of the above processes. The one or more processors may execute each of the above processes according to the program read out from the one or more memories, or may execute each of the above processes according to a logic circuit designed in advance to execute each of the above processes. The processor may be any of various processors suitable for computer control, such as a CPU, a graphics processing unit (GPU), a digital signal processor (DSP), a field programmable gate array (FPGA), and an application specific integrated circuit (ASIC). Note that the plurality of physically separated processors may also cooperate with each other to execute the above processes.

Although the present disclosure has been described above through description of the embodiments, the above-described embodiments are merely examples, and the present disclosure is not limited to only the above-described embodiments. The scope of the present disclosure is indicated by the claims, taking into consideration the detailed description of the disclosure, and encompasses all modifications within the meaning and scope equivalent to the wording described therein.

1. An in-vehicle communication system comprising:
a first control device; and
a plurality of first electrical devices, wherein:
the first control device includes:
a first power source configured to output power;
a plurality of first communication interfaces respectively corresponding to the plurality of first electrical devices;
a plurality of first communication paths respectively corresponding to the plurality of first communication interfaces; and
a first processor configured to judge first priority levels for supplying power from the first power source to the plurality of first electrical devices, p1 the first processor transmits a first transmission request from the plurality of first communication interfaces to each first electrical device of the plurality of first electrical devices via the plurality of first communication paths,
the each first electrical device of the plurality of first electrical devices transmits information indicating importance and required power of the first electrical device to the first control device via a first communication path of the plurality of first communication paths in response to the first transmission request, and
the first processor judges the first priority levels based on the information indicating the importance and the required power received from the plurality of first electrical devices.

2. The in-vehicle communication system according to claim 1,
wherein the first power source supplies the plurality of first electrical devices with communication power necessary for the plurality of first electrical devices to respectively communicate with the first control device via the plurality of first communication paths when the first processor transmits the first transmission request.

3. The in-vehicle communication system according to claim 1, wherein:
the first control device further includes at least one superimposing unit,
the superimposing unit generates a superimposed signal by superimposing a communication signal output from a first communication interface of the plurality of first communication interfaces and the power supplied from the first power source, and outputs the superimposed signal to the first communication path corresponding to the first communication interface that output the communication signal, and
the superimposing unit separates a signal including the information indicating the importance and the required power from a transmission signal transmitted from the first electrical device via the first communication path, and outputs separated information to the first processor via the first communication interface corresponding to the first electrical device that output the transmission signal.

4. The in-vehicle communication system according to claim 3, wherein:
the each first electrical device of the plurality of first electrical devices includes:
a separation unit configured to separate a signal including the first transmission request from the superimposed signal transmitted via the first communication path corresponding to the first electrical device; and
a communication interface configured to transmit the information indicating the importance and the required power of the first electrical device to the first control device via the first communication path in response to the first transmission request separated by the separation unit.

5. The in-vehicle communication system according to claim 4, wherein:
the separation unit further separates power from the superimposed signal transmitted via the first communication path corresponding to the first electrical device, and
the each first electrical device of the plurality of first electrical devices further includes a power receiver configured to first supply the power separated by the separation unit to the communication interface.

6. The in-vehicle communication system according to claim 1,
wherein the first processor changes the first priority levels according to a state of a vehicle in which the in-vehicle communication system is mounted.

7. The in-vehicle communication system according to claim 1, further comprising
a second control device and a plurality of second electrical devices, wherein:
at least one first electrical device of the plurality of first electrical devices is a specific electrical device,
the second control device includes:
a second power source configured to output power;
a plurality of second communication interfaces respectively corresponding to the plurality of second electrical devices and the specific electrical device;
plurality of second communication paths respectively corresponding to the plurality of second communication interfaces; and
a second processor configured to judge second priority levels for supplying power from the second power source to the plurality of second electrical devices and the specific electrical device,
the second processor transmits a second transmission request to each second electrical device of the plurality of second electrical devices from the plurality of second communication interfaces via the plurality of second communication paths,
the each second electrical device of the plurality of second electrical devices transmits information indicating importance and required power of the second electrical device to the second control device via a second communication path of the plurality of second communication paths in response to the second transmission request,
the second processor judges the second priority levels based on the information indicating the importance and the required power received from the plurality of second electrical devices, and
in response to a reduction of the power supplied from the first power source to the specific electrical device, the second processor changes the second priority levels such that power is supplied from the second power source to the specific electrical device.

8. The in-vehicle communication system according to claim 7,
wherein the first processor notifies the second processor of information indicating that the power supplied from the first power source to the specific electrical device is to be reduced.

9. The in-vehicle communication system according to claim 7,
wherein the specific electrical device notifies the second processor of information indicating that the power supplied from the first power source to the specific electrical device is to be reduced.

10. The in-vehicle communication system according to claim 8,
wherein the information indicating that power is to be reduced includes information indicating the importance and the required power of the specific electrical device.

11. A control device to be mounted in a vehicle, the control device comprising:
a power source configured to output power;
a plurality of communication interfaces; and
a processor configured to judge priority levels for supplying power from the power source to a plurality of electrical devices that are mounted in the vehicle and respectively correspond to the plurality of communication interfaces via a plurality of communication paths respectively corresponding to the plurality of communication interfaces, wherein:
the processor transmits a transmission request to each electrical device of the plurality of electrical devices from the plurality of communication interfaces via the plurality of communication paths,
the processor receives, from the each electrical device of the plurality of electrical devices, information indicating importance and required power of the electrical device in response to the transmission request via the communication path, and
the processor judges the priority levels based on the information indicating the importance and the required power received from the plurality of electrical devices.

12. A control device to be mounted in a vehicle, the control device comprising:
a power source configured to output power;
a plurality of communication interfaces; and
a processor configured to judge priority levels for supplying power from the power source to a plurality of electrical devices mounted in the vehicle via a plurality of communication paths respectively corresponding to the plurality of communication interfaces, wherein:
at least one electrical device among the plurality of electrical devices is a specific electrical device, and the processor transmits a transmission request from the plurality of communication interfaces via the plurality of communication paths to electrical devices other than the specific electrical device,
the processor receives information indicating the importance and the required power of the electrical devices other than the specific electrical device via the communication paths in response to the transmission request,
the processor judges the priority levels based on the information indicating the importance and the required power received from the electrical devices other than the specific electrical device, and
in response to a reduction in power supplied to the specific electrical device from an in-vehicle device other than the control device, the processor changes the priority levels such that power is supplied to the specific electrical device from the power source.

13. An electrical device to be mounted in a vehicle, the electrical device comprising:
a separation unit configured to separate a communication signal from a superimposed signal in which power and the communication signal are superimposed, the superimposed signal being transmitted from a control device mounted in the vehicle via a communication path; and
a communication interface configured to transmit information indicating importance and required power of the electrical device to the control device via the communication path in response to a transmission request included in the communication signal.

14. The electrical device according to claim 13, wherein:
the separation unit further separates the power from the superimposed signal transmitted via the communication path, and
the electrical device further comprises a power receiver configured to first supply the power separated by the separation unit to the communication interface.

15. The electrical device according to claim 14, further comprising
another separation unit configured to receive supply of power from an in-vehicle device other than the control device, that is mounted in the vehicle, via another path separate from the communication path in response to the power supplied from the control device being reduced, the other separation unit being separate from the separation unit,
wherein the other separation unit separates the power from a superimposed signal in which the power and the communication signal are superimposed and which is supplied from the in-vehicle device via the other path, and outputs the separated power to the power reception unit.

16. The in-vehicle communication system according to claim 2, wherein:
the first control device further includes at least one superimposing unit,
the superimposing unit generates a superimposed signal by superimposing a communication signal output from a first communication interface of the plurality of first communication interfaces and the power supplied from the first power source, and outputs the superimposed signal to the first communication path corresponding to the first communication interface that output the communication signal, and
the superimposing unit separates a signal including the information indicating the importance and the required power from a transmission signal transmitted from the first electrical device via the first communication path, and outputs separated information to the first processor via the first communication interface corresponding to the first electrical device that output the transmission signal.

17. The in-vehicle communication system according to claim 2,
wherein the first processor changes the first priority levels according to a state of a vehicle in which the in-vehicle communication system is mounted.

18. The in-vehicle communication system according to claim 3,
wherein the first processor changes the first priority levels according to a state of a vehicle in which the in-vehicle communication system is mounted.

19. The in-vehicle communication system according to claim 4,
wherein the first processor changes the first priority levels according to a state of a vehicle in which the in-vehicle communication system is mounted.

20. The in-vehicle communication system according to claim 5,
wherein the first processor changes the first priority levels according to a state of a vehicle in which the in-vehicle communication system is mounted.
